(19) United States
(12) Patent Application Publication
(10) Pub. No.: US 2024/0422480 A1
(43) Pub. Date: Dec. 19, 2024

(54) PIEZOELECTRIC TRANSDUCER WITH DIFFERENT POLING DIRECTIONS

(71) Applicant: TEXAS INSTRUMENTS INCORPORATED, Dallas, TX (US)

(72) Inventor: Bichoy Bahr, Allen, TX (US)

(21) Appl. No.: 18/528,673

(22) Filed: Dec. 4, 2023

Related U.S. Application Data
(60) Provisional application No. 63/508,338, filed on Jun. 15, 2023.

(51) Int. Cl. H04R 17/02; H04R 17/00; H04R 31/00

(52) U.S. Cl. CPC H04R 17/025; H04R 17/005; H04R 31/006

(57) ABSTRACT

A transducer device is described that includes a substrate having an opening, and a cantilever device having a first end on the substrate and a second end suspended over the opening. In at least one example, the cantilever device includes a first piezoelectric layer having a first surface, the first piezoelectric layer having a first poling direction. The cantilever device further includes a second piezoelectric layer having a second surface opposing the first surface, the second piezoelectric layer having a second poling direction, the second poling direction being different from the first poling direction. The cantilever device further includes a first electrode on the first surface, and a second electrode on the second surface.

### CROSS-RELATED APPLICATION

This application claims priority to U.S. Provisional Patent Application No. 63/508,338, filed on Jun. 15, 2023, titled “OUT-OF-PLANE PIEZOELECTRIC MEMS ACTUATOR AND SENSOR WITH STACKED PIEZOELECTRIC LAYERS,” and which is incorporated by reference in entirety.

### BACKGROUND

A transducer can convert between mechanical energy (e.g., vibration) and electrical energy. A transducer can be in the form of a cantilever including a flap (e.g., a piezoelectric flap) suspended over an opening. The flap can vibrate in response to a stimulus (e.g., sound waves, weight, etc.) and generate electrical signals representing the stimulus. The electrical signals can then be further processed to extract information. For example, when the stimulus is sound waves, the electrical signals are processed to generate an audio signal. In another example, when the stimulus is a speed, the electrical signals may generate a measure of acceleration.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIG. 1 is a schematic illustrating a system with a transducer having two electrodes and two piezoelectric layers with different poling directions, in accordance with at least one example.

FIG. 2A is a schematic illustrating a cross-section of the transducer of FIG. 1, in accordance with at least one example.

FIG. 2B is a plot of an electric field across electrodes of the transducer of FIG. 1, in accordance with at least one example.

FIG. 2C is a plot of a voltage across electrodes of the transducer of FIG. 1, in accordance with at least one example.

FIGS. 3A, 3B, and 3C are plots of lateral strain in an x-direction of the transducer, electric field along a z-direction of the transducer, and voltage difference between the electrodes of the transducer, respectively, in accordance with some examples.

FIG. 4 is a schematic illustrating an acoustic system with an acoustic device and having a microphone that includes the transducer of FIG. 2A, in accordance with at least one example.

FIG. 5 is a schematic illustrating a cross-sectional view of the acoustic device, in accordance with at least one example.

FIG. 6 is a schematic illustrating a cross-sectional view of the microphone, in accordance with at least one example.

FIG. 7 is a schematic illustrating a cross-section view of a transducer with two electrodes and two piezoelectric layers formed on different wafers, in accordance with at least one example.

FIG. 8A is a schematic illustrating a transducer configured as an accelerometer, in accordance with at least one example.

FIG. 8B is a schematic illustrating a transducer configured as a sensor, in accordance with at least one example.

FIG. 9 is a flowchart of a method of forming a transducer, in accordance with at least one example.

FIG. 10 is a flowchart of a method of forming a transducer with two wafers, in accordance with at least one example.

FIG. 11 is a flowchart of a method of forming a transducer with piezoelectric layers fabricated with different processes, in accordance with at least one example.

### SUMMARY

In at least one example, an apparatus is described which comprises a substrate having an opening, and a cantilever device having a first end on the substrate, and a second end suspended over the opening. The cantilever comprises a first piezoelectric layer having a first surface, the first piezoelectric layer having a first poling direction. In at least one example, the cantilever further comprises a second piezoelectric layer having a second surface opposing the first surface, the second piezoelectric layer having a second poling direction which is different from the first poling direction. The cantilever further comprises a first electrode on the first surface, and a second electrode on the second surface. In at least one example, the first poling direction has a first component along an axis orthogonal to the first surface, the second poling direction has a second component along the axis, and the first component and the second component have same magnitude and opposite directions.

In at least one example, a method is described which comprises forming a substrate having an opening and forming a cantilever device having a first end on the substrate and a second end suspended over the opening. The method of forming the cantilever device includes forming a first piezoelectric layer having a first poling direction, the first piezoelectric layer having a first surface. In at least one example, forming the cantilever device includes forming a second piezoelectric layer having a second poling direction different from the first poling direction, the second piezoelectric layer having a second surface opposing the first surface. The method of forming the cantilever device comprises forming a first electrode on the first surface and forming a second electrode on the second surface.

In at least one example, forming the first electrode and forming the first piezoelectric layer includes forming the first electrode and the first piezoelectric layer on a first wafer including the substrate, the first piezoelectric layer having a third surface opposing the first surface. In at least one example, forming the second electrode and forming the second piezoelectric layer includes forming the second electrode and the second piezoelectric layer on a second wafer, the second piezoelectric layer having a fourth surface opposing the second surface. The method of forming the cantilever device includes bonding the third surface to the fourth surface. The method of forming the cantilever device further includes removing the second wafer from the second piezoelectric layer and the second electrode and etching the substrate to form the opening.

In at least one example, an apparatus is described which comprises a substrate having an opening, and a cantilever device having a first end on the substrate and a second end suspended over the opening. The cantilever device includes a first piezoelectric layer having a first surface, the first piezoelectric layer having a first poling direction. In at least one example, the cantilever device includes a second piezoelectric layer having a second surface opposing the first surface, the second piezoelectric layer having a second poling direction different from the first poling direction. The cantilever device further includes a first electrode on the first surface, and a second electrode on the second surface. In at least one example, the first poling direction has a first component along an axis orthogonal to the first surface, the second poling direction has a second component along the axis, and the first component and the second component have same magnitude and opposite directions.

### DETAILED DESCRIPTION

A transducer can convert between mechanical energy (e.g., vibration) and electrical energy. A transducer can be in the form of a cantilever including a flap (e.g., a piezoelectric flap) suspended over an opening. A piezoelectric flap may be a piezoelectric bimorph flap which includes three electrodes and two piezoelectric layers between the electrodes. For example, a piezoelectric bimorph flap may include a top electrode over an upper piezoelectric layer, a bottom electrode between the upper and lower piezoelectric layers, and a bottom electrode under the lower piezoelectric layer. As the piezoelectric bimorph flap bends up or down due to a stimulus, if the bimorph flap is symmetric, equal and opposite strain may develop across the upper and lower piezoelectric layers, and the resulting strain can have an odd symmetry around a neutral axis. The neutral axis can be an axis parallel to the surface and normal to the force direction. The neutral axis can be the line along which there is zero stress in the material. This happens because the stress/strain flips direction between top portion and bottom portion from compressive to tensile (or vice versa depending on the direction of bending). If the piezoelectric bimorph flap has a symmetric structure (e.g., being symmetric in material), the neutral axis can be exactly in the center. If there is asymmetry, the neutral axis may move up or down.

In a case where the upper and lower piezoelectric materials are homogenous materials, the piezoelectric layers can have a same poling direction (or a same intrinsic polarization direction). The strain can produce an upper electric field in the upper piezoelectric material and a lower electric field in the lower piezoelectric material that also have an odd symmetry (e.g., opposite polarity but equal in magnitude) around the neutral axis of the piezoelectric bimorph flap, and the net electric field between the top and bottom electrodes cancel. Accordingly, the middle electrode at the interface between the upper and lower piezoelectric layers is provided, which allows separate measurement of the upper and lower electric fields to measure the strains caused by the stimulus.

Forming the middle electrode between the lower and upper piezoelectric layers presents a challenge. For example, the crystal quality/crystallinity of a piezoelectric layer can be the best if grown on silicon, and the crystal quality of the upper piezoelectric layer may be compromised after depositing the middle electrode over the lower piezoelectric layer and then depositing the material for forming the upper piezoelectric layer. The middle electrode may introduce mass loading that may reduce the resonance frequency of the transducer. The middle electrode may also increase manufacturing cost due to additional masks used for patterning vias for connecting to the middle electrode through the upper and lower piezoelectric layers.

Disclosed herein is a transducer which comprises two piezoelectric layers with different poling directions (or different intrinsic polarization directions) and two electrodes. The two electrodes include a top electrode on top of the first surface of a first piezoelectric layer (e.g., upper piezoelectric layer), and a bottom electrode on a second surface of a second piezoelectric layer (e.g., lower piezoelectric layer). In one example, respective surfaces of the first piezoelectric layer and the second piezoelectric layer, that do not have electrodes on them face one another. These respective surfaces may have no intermediate material between them. In at least one example, these respective surfaces may have a bonding material between them. The transducer may be in the form of a cantilever, where the first end of the cantilever is on a substrate having an opening, and a second end of the cantilever is suspended over the opening. The cantilever can be a beam, a diaphragm, a set of cantilever beams with non-uniform cross-sections, partial membranes, membranes with slits, etc. The cantilever can be configured as a piezoelectric microphone, a piezoelectric speaker, a piezoelectric micromachine ultrasonic transducer, a piezoelectric accelerometer, or an audio accelerometer.

In least one example, the respective directions of poling of the first piezoelectric layer and the second piezoelectric layer are such that a first component of a first poling direction of the first piezoelectric layer is opposite to a second component of a second poling direction of the second piezoelectric layer, where both the first and second components are orthogonal to the neural axis. The neutral axis can be an axis parallel to the surface and normal to the force direction. In at least one example, different poling directions are achieved by crystal growth. In at least one example, different poling directions are achieved by flipping and bonding two films of piezoelectric layers having the same poling direction, so that the resulting piezoelectric layers have opposite poling directions.

The examples discussed herein can provide various advantages. For example, the fabrication process of forming a transducer device is simplified by removing the middle electrode between the top electrode and the bottom electrode. A savings of at least two fabrication masks is achieved by not forming the middle electrode between the piezoelectric layers. For instance, the interconnect routing, forming of vias, and trenches to connect to the middle electrode is avoided by using two piezoelectric layers with intrinsic opposite poling (or polarization) and two electrodes (e.g., top electrode and bottom electrode). By using two piezoelectric layers with intrinsic opposite poling, strain-electric field coupling is observed through an entire volume of the transducer device. In one instance, coupling coefficient k² for the transducer device of various examples exceeds the coupling coefficient k² of three-electrode based bimorph piezoelectric structures and two-electrode based uni-morph structures. Other technical effects will be evident from various examples described herein. Here, the same reference numbers or other reference designators are used in the drawings to designate the same or similar (either by function and/or structure) features.

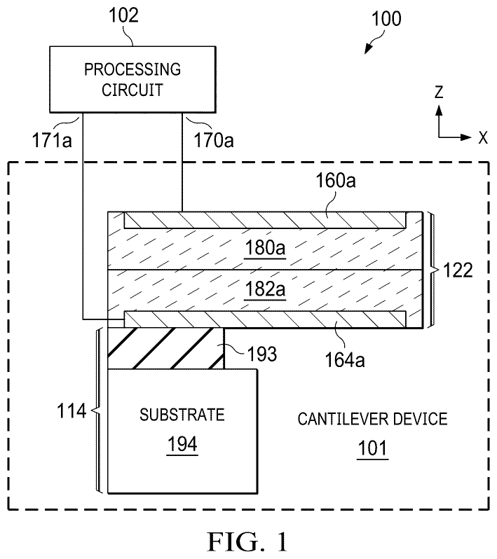

FIG. 1 is a schematic illustrating a system 100 with a transducer having two electrodes and two piezoelectric layers with different poling directions, in accordance with at least one example. System 100 comprises a cantilever device 101 and a processing circuit 102. Cantilever device 101 comprises semiconductor structure 114 (e.g., fixed constraint) and a bimorph piezoelectric cantilever 122, part of which is on semiconductor structure 114. In at least one example, bimorph piezoelectric cantilever 122 comprises a first electrode 160a (e.g., top electrode), a second electrode 164a (e.g., bottom electrode), a first piezoelectric layer 180a, and a second piezoelectric layer 182a. First electrode 160a is on a first surface (e.g., top surface) of first piezoelectric layer 180a. Second electrode 164a is on a second surface (e.g., bottom surface) of second piezoelectric layer 182a. In at least one example, first electrode 160a and second electrode 164a extend along the x-direction no more than half of a respective length (along the x-direction) of first piezoelectric layer 180a and second piezoelectric layer 182a.

First piezoelectric layer 180a is adjacent to second piezoelectric layer 182a, and there is no electrode between them. In at least one example, first piezoelectric layer 180a directly abuts with second piezoelectric layer 182a. In at least one example, first piezoelectric layer 180a couples with second piezoelectric layer 182a via a bonding material. First piezoelectric layer 180a and second piezoelectric layer 182a have identical material or different materials. In at least one example, first piezoelectric layer 180a and second piezoelectric layer 182a are fabricated or deposited using different fabrication processes. First piezoelectric layer 180a and second piezoelectric layer 182a can have identical thicknesses or different thicknesses (e.g., along the z-direction).

First piezoelectric layer 180a has a first poling direction. Second piezoelectric layer 182a has a second poling direction. The different poling directions can be due to the different intrinsic polarization directions between first piezoelectric layer 180a and second piezoelectric layer 182a. In at least one example, the second poling direction has a second component which is different (e.g., opposite) to a first component of the first poling direction. In at least one example, the first component and the second component have the same magnitude and opposite directions. In at least one example, the first and second components are along an axis orthogonal to the first surface (and the neutral axis). In at least one example, first piezoelectric layer 180a has a different crystallinity or crystallization than second piezoelectric layer 182a. For instance, first piezoelectric layer 180a has a first crystallinity or crystallization which is a flipped mirror image of a second crystallinity of crystallization of second piezoelectric layer 182a.

The fabrication process of forming bimorph piezoelectric cantilever 122 is simplified by not having the middle electrode between first electrode 160a (e.g., top electrode) and second electrode 164a (e.g., bottom electrode). A savings of at least two fabrication masks is achieved by not forming the middle electrode between first piezoelectric layer 180a and second piezoelectric layer 182a. For instance, the interconnect routing, and forming of vias and trenches to connect to the middle electrode is avoided by using first piezoelectric layer 180a and second piezoelectric layer 182a with intrinsic opposite poling (or polarization).

In at least one example, first electrode 160a is coupled to processing circuit 102 by terminal 170a while second electrode 164a is coupled to processing circuit 102 by terminal 171a. Processing circuit 102 comprises (or is part of) an integrated circuit which includes logic and or circuit to convert the analog voltage developed on first electrode 160a and second electrode 164a to a processed signal (e.g., an audio signal, sensor output, etc.). Processing circuit 102 can apply a voltage on first electrode 160a and second electrode 164a to actuate bimorph piezoelectric cantilever 122. In at least one example, processing circuit 102 includes logic to set a state of first electrode 160a, second electrode 164a, first piezoelectric layer 180a, and second piezoelectric layer 182a. For instance, processing circuit 102 can clamp or fix an edge of first electrode 160a, second electrode 164a, first piezoelectric layer 180a and second piezoelectric layer 182a to semiconductor structure 114. In at least one example, processing circuit 102 is an application specific integrated circuit (ASIC). In at least one example, processing circuit 102 includes one or more physical processor devices executing instructions stored in non-transitory memory to perform the processing and control functions discussed herein.

Semiconductor structure 114 comprises an oxide layer 193 and a substrate 194. In at least one example, oxide layer 193 may be absent and substrate 194 may directly couple to second electrode 164a and/or second piezoelectric layer 182a. In at least one example, substrate 194 does not extend entirely along the length of bimorph piezoelectric cantilever 122 and leaves an opening over which a part of bimorph piezoelectric cantilever 122 is suspended. The opening allows bimorph piezoelectric cantilever 122 to bend or vibrate based on a stimulus which may be provided through the opening or provided via terminals 170a and 171a to bimorph piezoelectric cantilever 122.

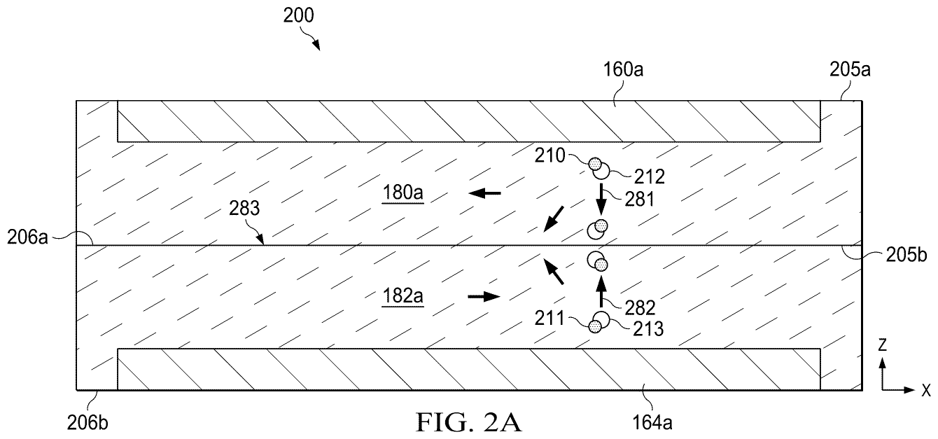

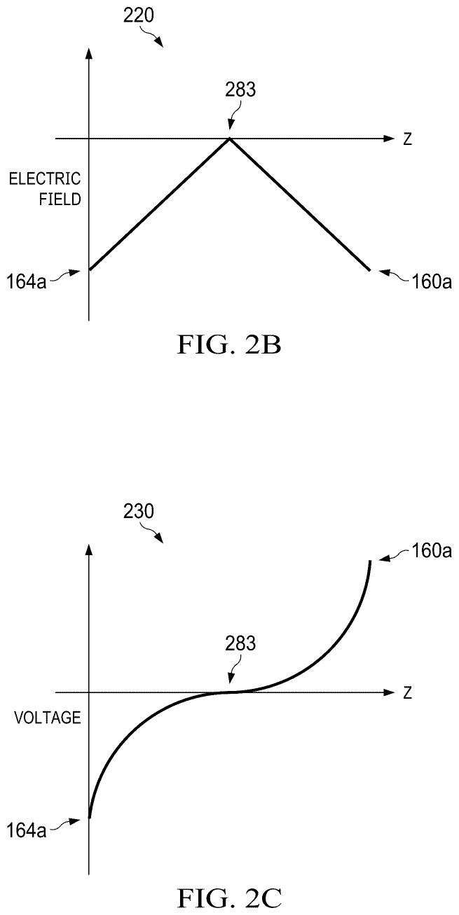

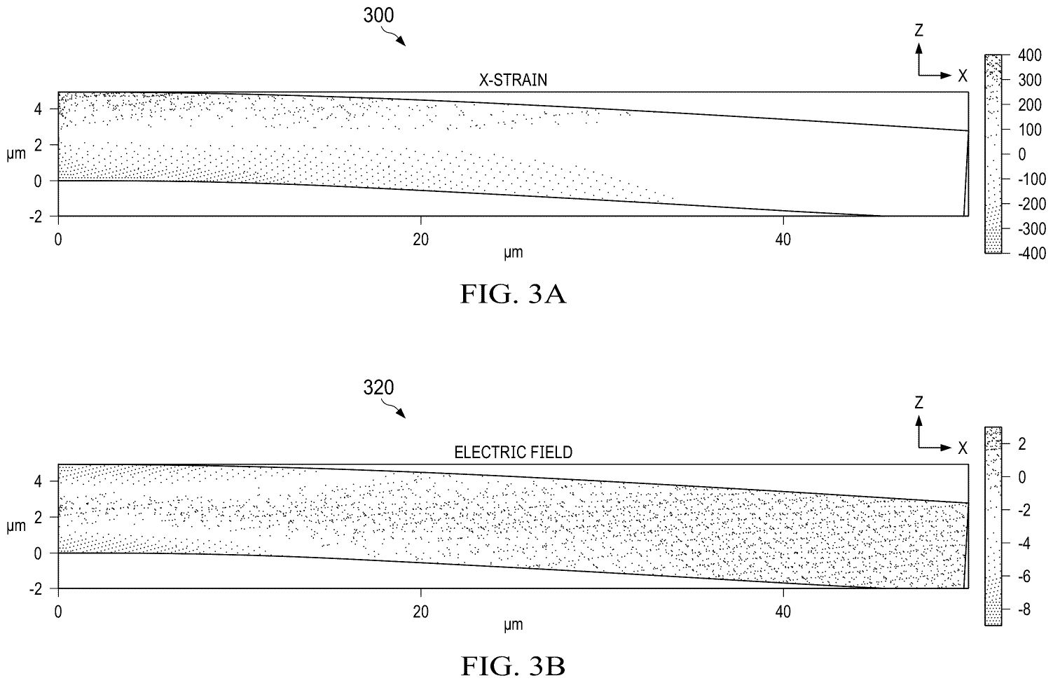

FIG. 2A is a schematic illustrating a cross-section 200 of the transducer of FIG. 1, in accordance with at least one example. Cross-section 200 illustrates the surfaces of first piezoelectric layer 180a and second piezoelectric layer 182a. These surfaces include a first surface 205a (e.g., top surface) and an opposing second surface 206a (e.g., bottom surface) of first piezoelectric layer 180a, and a third surface 205b (e.g., top surface) and an opposing fourth surface 206b (e.g., bottom surface) of second piezoelectric layer 182a. First electrode 160a is on first surface 205a while bottom electrode 164a is on fourth surface 206b. Here, interface surface 283 is between second surface 206a of first piezoelectric layer 180a and third surface 205b of second piezoelectric layer 182a. In at least one example, interface surface 283 indicates direct abutting or attachment of second surface 206a with third surface 205b. In at least one example, interface surface 283 indicates indirect abutting or attachment of second surface 206a with third surface 205b. For instance, a bonding material may be between second surface 206a and third surface 205b.

In at least one example, first piezoelectric layer 180a and second piezoelectric layer 184a comprise aluminum nitride (AlN). In at least one example, the thickness of first piezoelectric layer 180a comprising AlN having a thickness configured to increase/maximize SNR and sensitivity. For example, the thickness of AlN is substantially in a range of 200 nm to 500 nm to maximize SNR and sensitivity. As discussed herein, a first component of the first poling direction of first piezoelectric layer 180a is opposite to a second component of the second poling direction of second piezoelectric layer 182a. Cross-section 200 illustrates AlN compounds in first piezoelectric layer 180a and second piezoelectric layer 182a. Here, nitrogen atom 210 and aluminum atom 212 are shown in first piezoelectric layer 180a, while nitrogen atom 211 and aluminum atom 213 are in second piezoelectric layer 182a. In this example, first poling direction 281 extends along the-z direction from aluminum atom 212 of a first AlN compound to nitrogen atom 210 of a second AlN compound in first piezoelectric layer 180a. Second poling direction 282 extends along the z direction from aluminum atom 213 of a first AlN compound to nitrogen atom 211 of a second AlN compound in second piezoelectric layer 182a, where second poling direction 282 is opposite first poling direction 281. In at least one example, the poling directions can be arbitrary directions in first piezoelectric layer 180a and second piezoelectric layer 182a so long as the poling directions have at least one component which is opposite (e.g., a component of poling direction in first piezoelectric layer 180a is opposite to a component of poling direction in second piezoelectric layer 182a). For example, as shown in FIG. 2A, first piezoelectric layer 180a may have a poling direction 283 having a component 283a parallel with surfaces 206a/205b and a component 283b orthogonal to surfaces 206a/205b. Also, second piezoelectric layer 182a may have a poling direction 285 having a component 285a parallel with surfaces 206a/205b and a component 285b orthogonal to surfaces 206a/205b. Components 283b and 285b can have opposite directions but have the same magnitude. In at least one example, the poling directions in first piezoelectric layer 180a and second piezoelectric layer 182a are orthogonal directions, where poling direction of one layer is opposite to poling direction in the other layer.

FIG. 2B is a plot 220 of an electric field E across a thickness of first piezoelectric layer 180a and a thickness of second piezoelectric layer 182a between first electrode 160a and second electrode 164a of FIG. 1 and FIG. 2A, in accordance with at least one example. The electric field E(\vec{E}=−∇V) along the z-direction decreases from location z0 (e.g., at second electrode 164a) to location z1 (e.g., at surfaces 206a/205b or interface surface 283) and increases from location z1 to location 22 (e.g., at first electrode 160a). The electric field has the same polarity (e.g., pointing at a negative z direction) throughout, due to the opposing components of the poling directions in first piezoelectric layer 180a and second piezoelectric layer 182a.

FIG. 2C is a plot 230 of a voltage across electrodes of the transducer of FIG. 1, in accordance with at least one example. Integrating the electric field E of FIG. 2B results in a voltage across second electrode 164a to first electrode 160a. This voltage is expressed as:

$$V = - {\int }_{z 1}^{z 0} E dz \qquad ( 1 )$$

The voltage V is a non-zero voltage between second electrode 164a and first electrode 160a because of opposing components of the poling directions in first piezoelectric layer 180a and second piezoelectric layer 182a, in accordance with at least one example.

A piezoelectric layer has a corresponding electro-mechanical coupling coefficient k², which represents a percentage of energy the piezoelectric material can transform/transduce between electrical to mechanical domain. A phenomenological model derived from thermodynamic potentials mathematically describes the property of piezoelectricity. In the case of piezoelectric layer (e.g., first piezoelectric layer 180a) under isothermal and adiabatic conditions, and ignoring higher order effects, the elastic Gibbs function may be described by:

$${G}_{1} = - \frac{1}{2} ( {s}_{ij kl}^{D} {T}_{kl} {T}_{ij} + 2 {g}_{nij} {D}_{n} {T}_{ij} ) + \frac{1}{2} {β}_{mn}^{T} {D}_{m} {D}_{n} \qquad ( 2 )$$

where g is the piezoelectric voltage coefficient, s is the elastic compliance, and β is the inverse permittivity. The independent variables in this equation are the stress T and the electric displacement D. The superscripts of the constants designate the independent variable that is held constant when defining the constant, and the and the subscripts define tensors that consider the anisotropic nature of the material.

The linear equations of piezoelectricity for this potential are determined from the derivative of Gibbs function G₁ and are:

$${S}_{ij} = \frac{{dG}_{1}}{{dT}_{ij}} = {s}_{ijkl}^{D} {T}_{kl} + {g}_{nij} {D}_{n} \qquad ( 3 )$$

$${E}_{m} = \frac{{dG}_{1}}{{dD}_{m}} = {β}_{mn}^{T} {D}_{m} + {g}_{nij} {T}_{ij} \qquad ( 4 )$$

where S is the strain and E is the electric field. The elements of the tensor are reduced to a 6×6 matrix with 1, 2, and 3 designating the normal stress and strain and 4, 5, and 6 designating the shear stress and strain elements. Thermodynamic potentials may be used to represent linear equations of piezoelectricity as follows:

$${S}_{p} = {s}_{pq}^{D} {T}_{q} + {g}_{pm} {D}_{m} \qquad ( 5 )$$

$${E}_{m} = {β}_{mn}^{T} {D}_{m} - {g}_{pm} {T}_{p} \qquad ( 6 )$$

$${S}_{p} = {s}_{pq}^{E} {T}_{q} + {d}_{pm} {E}_{m} \qquad ( 7 )$$

$${D}_{m} = {ϵ}_{mn}^{T} {E}_{n} - {d}_{pm} {T}_{p} \qquad ( 8 )$$

$${T}_{p} = {c}_{pq}^{E} {S}_{q} + {e}_{pm} {E}_{m} \qquad ( 9 )$$

$${D}_{m} = {ϵ}_{mn}^{T} {E}_{n} - {e}_{pm} {S}_{p} \qquad ( 10 )$$

$${T}_{p} = {c}_{pq}^{D} {S}_{q} + {h}_{pm} {D}_{m} \qquad ( 11 )$$

$${E}_{m} = {β}_{mn}^{s} {D}_{n} - {h}_{pm} {S}_{p} \qquad ( 12 )$$

where d, e, g, and h are piezoelectric constants, s and c are the elastic compliance and stiffness, respectively, and ϵ and β are the permittivity and the inverse permittivity, respectively.

The relationship of these equations can be represented in matrix form as:

$$[ \begin{matrix}{S}_{1} \\ {S}_{2} \\ {S}_{3} \\ {S}_{4} \\ {S}_{5} \\ {S}_{6} \\ {D}_{1} \\ {D}_{2} \\ {D}_{3}\end{matrix} ] = [ \begin{matrix}[ \begin{matrix}{S}_{11}^{E} & … & {S}_{16}^{E} \\ ⋮ & ⋱ & ⋮ \\ {S}_{61}^{E} & … & {S}_{66}^{E}\end{matrix} ] & [ \begin{matrix}{d}_{11} & … & {d}_{13} \\ ⋮ & ⋱ & ⋮ \\ {d}_{61} & … & {d}_{63}\end{matrix} ] \\ [ \begin{matrix}{d}_{11} & … & {d}_{16} \\ ⋮ & ⋱ & ⋮ \\ {d}_{31} & … & {d}_{d 36}\end{matrix} ] & [ \begin{matrix}{ϵ}_{11}^{T} & … & {ϵ}_{13}^{T} \\ ⋮ & ⋱ & ⋮ \\ {ϵ}_{31}^{T} & … & {ϵ}_{33}^{T}\end{matrix} ]\end{matrix} ] [ \begin{matrix}{T}_{1} \\ {T}_{2} \\ {T}_{3} \\ {T}_{4} \\ {T}_{5} \\ {T}_{6} \\ {E}_{1} \\ {E}_{2} \\ {E}_{3}\end{matrix} ] \qquad ( 13 )$$

The matrix is a generalized representation of the equations:

$${S}_{p} = {s}_{pq}^{E} {T}_{q} + {d}_{pm} {E}_{m} \qquad ( 14 )$$

$${D}_{m} = {ϵ}_{mn}^{T} {E}_{n} - {d}_{pm} {T}_{p} \qquad ( 15 )$$

Many elements of the matrix of equation (13) are zero or not independent due to the symmetry of the crystal which reduces the number of independent constants. The matrix of equation (13) has two independent free dielectric permittivities (ϵ₃₃^{T}, ϵ₁₁^{T}, =ϵ₂₂^{T}), three independent piezoelectric constants (d₃₃, d₃₁, d₁₅) and five independent elastic constants under short circuit boundary conditions (s₁₁^{E}=s₂₂^{E}, s₃₃^{E}, s₄₄^{E}=s₅₅^{E}, s₁₂^{E}=s₂₁^{E}, s₁₃^{E}=s₂₃^{E}, and s₂₃^{E}=2(s₁₁^{E}−s₂₂^{E})). The reduced matrix expresses the relationship between the material constants and the variables S, T, E, and D.

In at least one example, coefficient d₃₁ is a piezo coupling coefficient representing how much stress is coupled into electrical displacement and vice versa. The sign and magnitude are dependent on the material polarization. In at least one example, piezo coupling coefficient d₃₁ for first piezoelectric layer 180a has same magnitude as piezoelectric coupling coefficient d₃₁ of second piezoelectric layer 182a, but opposite polarity.

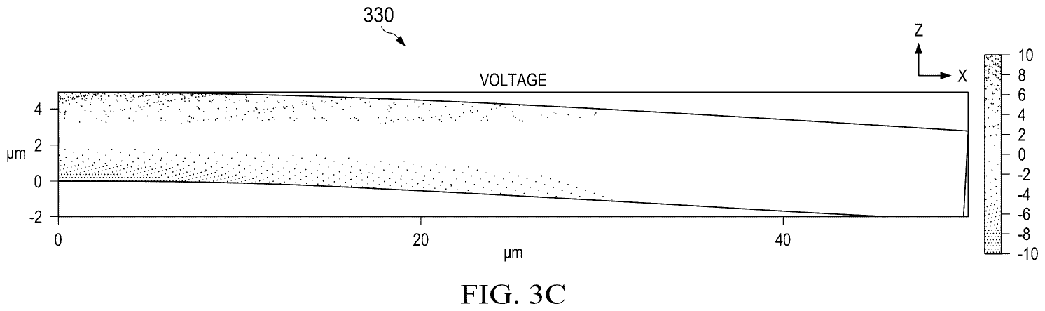

FIGS. 3A, 3B, and 3C are plots 300, 320, and 330 showing lateral strain in an x-direction of the transducer, electric field along a z-direction of the transducer, and a voltage difference between the electrodes of the transducer, respectively, in accordance with some examples. Plot 300 shows the lateral strain in the x-direction of bimorph piezoelectric cantilever 122. In at least one example, the lateral strain in the x-direction shows odd symmetry around the neutral axis of bimorph piezoelectric cantilever 122. Bimorph piezoelectric cantilever 122 has opposite polarities in first piezoelectric layer 180a (e.g., top layer) and second piezoelectric layer 182a (e.g., bottom layer). Plot 320 shows the electric field along the x-direction of bimorph piezoelectric cantilever 122. In at least one example, the electric field has an even symmetry around the neutral axis of bimorph piezoelectric cantilever 122. In at least one example, the electric field has the same sign along the z-direction because first piezoelectric layer 180a (e.g., top layer) and second piezoelectric layer 182a (e.g., bottom layer) have opposite material poling by construction. Plot 330 illustrates the voltage between first electrode 160a and second electrode 164a. In at least one example, owing to the even symmetry of the electric field, a voltage difference develops across first electrode 160a and second electrode 164a. In at least one example, the voltage can be sensed using first electrode 160a and second electrode 164a, in the absence of a middle electrode.

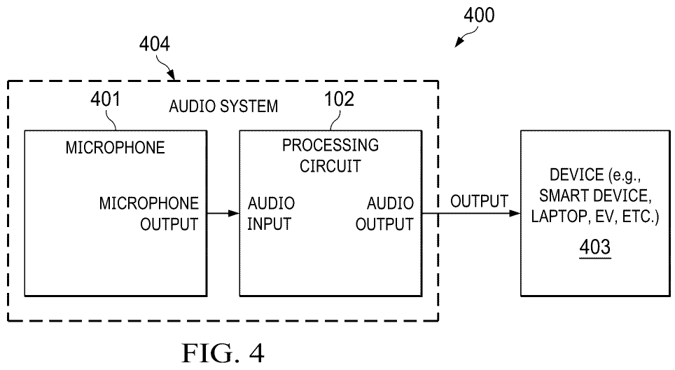

FIG. 4 is a schematic illustrating an acoustic system 400 that includes the transducer of FIG. 2A, in accordance with at least one example. In at least one example, acoustic system 400 comprises a microphone 401, processing circuit 102, and a device 403. In at least one example, microphone 401 and processing circuit 102 together form an audio system 404. Microphone 401 comprises a micro-electromechanical system (MEMS) or a nano-electromechanical system (NEMS) that converts mechanical energy from incident sound waves. Microphone 401 outputs an analog electrical signal on a microphone output to an audio input of processing circuit 102.

In at least one example, microphone 401 includes a plurality of cantilever flaps where an individual cantilever has similar features and functions as bimorph piezoelectric cantilever 122. The plurality of cantilever flaps may be arranged in any configuration (e.g., a rectangular array, a circular array, etc.). In at least one example, the plurality of cantilever flaps vibrates responsive to external sound waves and generates electrical signals representing the sound waves. In at least one example, the output from the plurality of cantilever flaps of microphone 401 is coupled to the microphone output. The microphone output is coupled to an audio input of processing circuit 102 of FIG. 1. In at least one example, an audio output couples to device 403 and provides a processed audio output (e.g., digital signal representing audio sensed by microphone 401) to device 403. In at least one example, device 403 is any suitable client that uses the audio output from audio system 404. Examples of device 403 include a smart device, a smart phone, a tablet, an electric vehicle, a wearable device, a computer, etc.

Processing circuit 102 comprises (or is part of) an integrated circuit which includes logic and or circuit to convert the audio input in an analog or acoustic domain (e.g., an analog signal) to the audio output in a digital domain or an electrical domain (e.g., digital signal). In at least one example, processing circuit 102 includes a power management circuit that turns off microphone 401 (e.g., by disconnecting its power supply or gating its power supply) during a low power (or sleep) mode or upon detecting a programmable or predetermined period of inactivity (e.g., when no sound is sensed by microphone 401). In some examples, audio device 104 includes a speaker including cantilever flaps in addition to microphone 401. In at least one example, bimorph piezoelectric cantilever 122 of microphone 401 is configured as a speaker. Also, in some other examples, a system (e.g., a stress sensor, an accelerometer, an energy harvester, etc.) may include a piezoelectric transducer having the cantilever flaps of some examples.

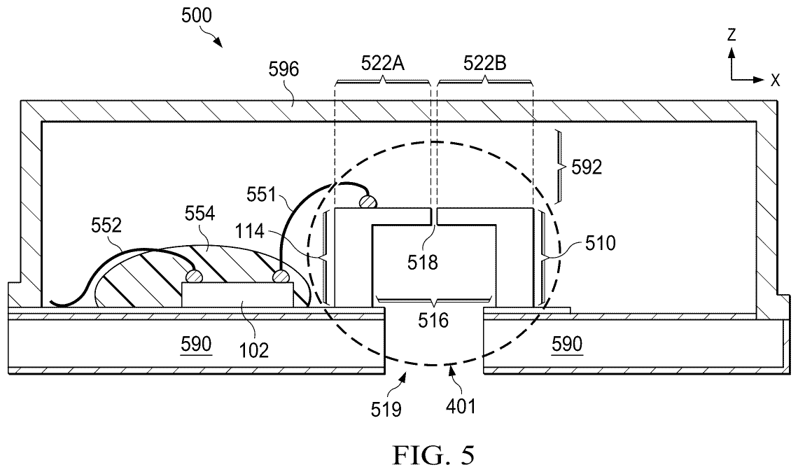

FIG. 5 is a schematic illustrating a cross-sectional view of an acoustic device 500, in accordance with at least one example. In at least one example, acoustic device 500 includes microphone 401 on substrate 590. Microphone 401 includes a piezoelectric cantilever system 510 on semiconductor structure 114, openings 516 and 519, and slit or opening 518. Piezoelectric cantilever system 510 includes piezoelectric flaps 522A and 522B. Acoustic device 500 further includes processing circuit 102 (e.g., an integrated circuit) encapsulated in epoxy 554, and bond wires 552 electrically coupled between processing circuit 102 and microphone 401. In at least one example, acoustic device 500 further includes a case or package 596 that encloses processing circuit 102, piezoelectric cantilever system 510 (of microphone 401), and back volume space 292.

In at least one example, acoustic device 500 is configured as a microphone. In at least one example, acoustic device 500 is configured as a speaker. In at least one example, acoustic device 500 is a packaged device including piezoelectric cantilever system 510 and integrated circuit 102 on a substrate 590. Substrate 590 can be a package substrate or a printed circuit board (PCB), etc. Substrate 590 comprises silicon oxide (SiO2) or any other suitable material.

In at least one example, piezoelectric cantilever system 510 includes piezoelectric flaps 522A and 522B. In at least one example, a membrane of each piezoelectric flap 522A and 522B has one end coupled to semiconductor structure 114 having opening 516, and the other end of each flap can move up and down as a cantilever or flap over opening 516. Each piezoelectric flap 522A and 522B includes two piezoelectric layers that abut each other and with electrodes on the top and bottom surfaces of the two piezoelectric layers, respectively. In at least one example, the poling directions in the two piezoelectric layers are orthogonal directions, where the poling direction of one layer is opposite to the poling direction in the other layer. This allows for removing a middle electrode between the two piezoelectric layers for each piezoelectric flap 522A and 522B.

In at least one example, slit or opening 518 separates piezoelectric flaps 522A and 522B. In at least one example, slit or opening 518 allows each flap to move independently with respect to each other in certain operations. In at least one example, processing circuit 102 controls each piezoelectric flap of piezoelectric cantilever system 510 individually. In at least one example, processing circuit 102 operates each piezoelectric flap 522A and 522B as a sensor (e.g., as part of a microphone to detect and convert sound waves into an electrical signal) or as an actuator (e.g., as a speaker to generate sound waves, or otherwise to move the flap). Piezoelectric cantilever system 510 is a MEMS or a NEMS, in which the flaps are fabricated within micron or nanometer dimensions, respectively.

In at least one example, an interconnect (e.g., bond wire 551) communicatively couples processing circuit 102 to piezoelectric cantilever system 510. In at least one example, epoxy 554 encapsulates processing circuit 102. In at least one example, piezoelectric cantilever system 510 and processing circuit 102 are on separate dies. In at least one example, piezoelectric cantilever system 510 and processing circuit 102 are on the same die.

In at least one example, substrate 590 also includes opening 519 that joins opening 516 and exposes piezoelectric flaps 522A and 522B to the exterior of acoustic device 500. Openings 516 and 519 define a front volume space (or an audio port). When processing circuit 102 operates piezoelectric flaps 522A and 522B as part of a microphone, piezoelectric flaps 522A and 522B detect sound waves that propagate from the exterior of acoustic device 500 via the front volume space defined by opening 516 and generate electrical signals responsive to the detection of the sound waves. In at least one example, from the electrical signals, processing circuit 102 extracts various properties of piezoelectric flaps 522A and 522B (e.g., frequency response, resonant frequency, etc.).

In at least one example, case or package 596 is mounted on substrate 590. Case or package 596 covers piezoelectric cantilever system 510, integrated circuit 102, bond wire 551, and epoxy 554. Case or package 596 is made of any suitable material, such as metal, plastic, etc., to shield piezoelectric cantilever system 510, and processing circuit 102 from noise and mechanical stress. Case or package 596 defines a back volume space 592 in which piezoelectric flaps 522A and 522B of piezoelectric cantilever system 510 can move (e.g., vibrate). In at least one example, air fills back volume space 592.

In at least one example, slit or opening 518 allows air to flow between back volume space 592 and front volume space (defined by opening 516) to equalize the air pressure on two sides of piezoelectric flaps 522A and 522B. In at least one example, slit or opening 518 allows air to flow between back volume space 592 and front volume space (defined by opening 516) to prevent stress which may otherwise rupture or reduce the sensitivity of piezoelectric flaps 522A and 522B in operating as a microphone. In at least one example, slit or opening 518 is narrow to prevent the sound waves from reaching back volume space 592, and sets the lower cut-off frequency of the microphone.

As discussed herein, the fabrication process of forming acoustic device 500 is simplified by removing the middle electrode between a top electrode and a bottom electrode on the piezoelectric layers of piezoelectric flaps 522A and 522B. A savings of at least two fabrication masks is achieved by not forming the middle electrode between the piezoelectric layers of piezoelectric flaps 522A and 522B. For instance, the interconnect routing, forming of vias, and trenches to connect to the middle electrode is avoided by using two piezoelectric layers, in each of piezoelectric flap 522A and 522B, with intrinsic opposite poling (or polarization) and two electrodes (e.g., top electrode and bottom electrode). In at least one example, a strain-electric field coupling is observed through an entire volume of piezoelectric flap 522A and 522B.

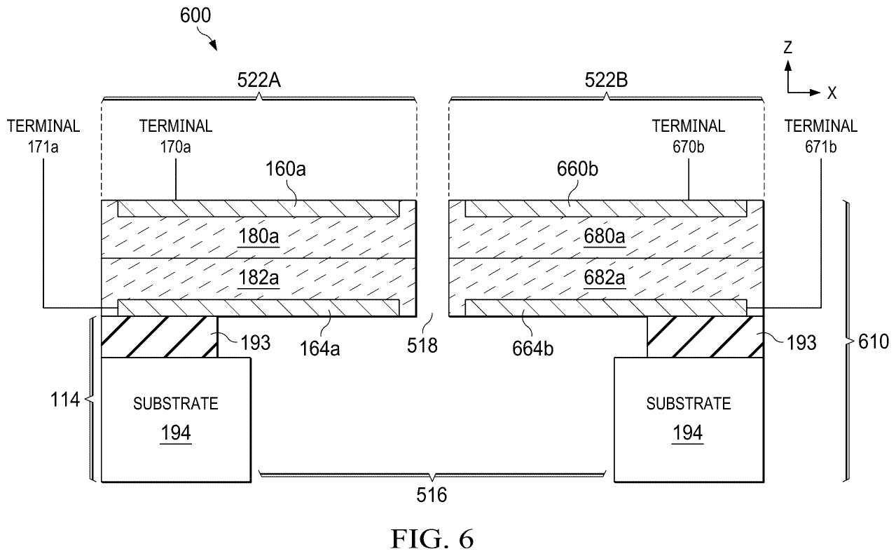

FIG. 6 is a schematic illustrating a cross-sectional view of a microphone 600, in accordance with at least one example. In at least one example, microphone 600 comprises piezoelectric cantilever system 610 that includes piezoelectric bimorph flaps 522A and 522B. In at least one example, slit or opening 518 separates piezoelectric bimorph flaps 522A and 522B. Each piezoelectric flap is a piezoelectric bimorph flap having a multi-layer structure. Bimorph flap 522A has first electrode 160a and second electrode 164a, and first piezoelectric layer 180a between first electrode 160a and second piezoelectric layer 182a. Second piezoelectric layer 182a is between second electrode 164a and first piezoelectric layer 180a. Bimorph flap 522B has a third electrode 660a (e.g., top electrode) and a fourth electrode 664a (e.g., bottom electrode), and a third piezoelectric layer 680a between top electrode 660a and a fourth piezoelectric layer 682a. Fourth piezoelectric layer 682a is between second electrode 664a and first piezoelectric layer 680a. Although the illustrated portion of piezoelectric cantilever system 610 shows two piezoelectric bimorph flaps 522A and 522B, piezoelectric cantilever system 610 may include any suitable number of piezoelectric bimorph flaps. In at least one example, piezoelectric bimorph flaps 522A and 522B can be in the cantilever systems described in U.S. patent application Ser. No. 18/240,668,titled “Piezoelectric Audio Device,” filed Aug. 31, 2023; U.S. patent application Ser. No. 18/495,675, titled “Wakeup Mechanism for an Audio System,” filed Oct. 26, 2023; U.S. patent application Ser. No. 18/522,145 titled “Piezoelectric Transducer having Tapered Cantilever,” filed Nov. 28, 2023, which are incorporated by reference in its entirety.

In at least one example, first electrode 160a and second electrode 164a couple to terminal 170a and terminal 171a, respectively. In at least one example, top electrode 660a and bottom electrode 664a couple to terminal 670b and terminal 671b, respectively. In at least one example, electrodes 160a, 164a, 660a, and 660b comprise one or more layers of any suitable conductive material(s). Electrodes 160a, 164a, 660a, and 660b and piezoelectric layers 180a, 182a, 680a, and 682b comprise material(s) compatible with CMOS processing. In at least one example, electrodes 160a, 164a, 660a, and 660b comprise molybdenum (Mo or “moly”). In at least one example, piezoelectric layers 180a, 182a, 680a, and 682b comprise aluminum nitride (“AlN”).

Piezoelectric layers 180a and 182a of piezoelectric flap 522A abut each other or couple one another via a bonding material. The poling directions in piezoelectric layers 180a and 182aof piezoelectric flap 522A are orthogonal directions, where the poling direction of piezoelectric layer 180a is opposite to the poling direction in piezoelectric layers 182a. This allows for removing a middle electrode between the two piezoelectric layers 180a and 182b for piezoelectric flap 522A. In at least one example, piezoelectric layers 680a and 682a of piezoelectric flap 522B abut each other or couple one another via a bonding material. In at least one example, the poling directions in piezoelectric layers 680a and 682a of piezoelectric flap 522B are orthogonal directions, where the poling direction of piezoelectric layer 680a is opposite to the poling direction in piezoelectric layers 682a. This allows for removing a middle electrode between the two piezoelectric layers 680a and 682b for piezoelectric flap 522B. As discussed herein, the fabrication process of forming microphone 600 is simplified by removing the middle electrode between first electrode 160a and second electrode 182a on the piezoelectric layer of piezoelectric flap 522A. Similarly, the middle electrode is removed from between third electrode 660a and fourth electrode 664b on the piezoelectric layer of piezoelectric flap 522B.

In at least one example, terminals 170a, 171a, 670b, and 671b can include any suitable electrical connector to transfer electrical current. In at least one example, terminals 170a and 171a electrically couple piezoelectric bimorph flap 522A to a first receiver (Rx) circuit (not shown). In at least one example, terminals 670b and 671b electrically couple piezoelectric bimorph flap 622B to a second Rx circuit (not shown). The first and second Rx circuits provide electrical signals sensed from across terminals 170a, 171a, 670b, and 671b to processing circuit 102 for processing. In at least one example, the first and second Rx circuits are part of processing circuit 102. In at least one example, terminals 170a and 171a electrically couple piezoelectric bimorph flap 522A to a first transmitter (Tx) circuit (not shown). In at least one example, terminals 670b and 671b electrically couple piezoelectric bimorph flap 622B to a second Tx circuit (not shown). In at least one example, microphone 600 is configured as a speaker. In one such example, the first and second Tx circuits provide electrical signals to terminals 170a, 171a, 670b, and 671b via processing circuit 102 to cause one or more of piezoelectric bimorph flaps 522A or 622B to actuate or bend to produce sound. In at least one example, the first and second Tx circuits are part of processing circuit 102.

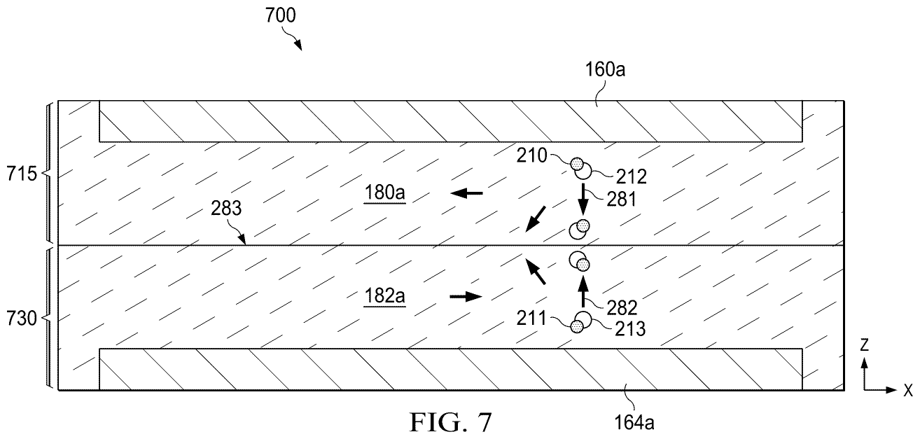

FIG. 7 is a schematic illustrating a cross-section view of a transducer 700 with two electrodes and two piezoelectric layers formed on different wafers or substrates, in accordance with at least one example. In at least one example, piezoelectric layers 180a and 182a are coupled to one another by forming each of the piezoelectric layers on separate wafers or substrates. In at least one example, first piezoelectric layer 180a is grown on a first substrate or wafer 715 while second piezoelectric layer 182b is grown on a second substrate or wafer 730. In at least one example, respective electrodes are formed on the top surfaces of respective piezoelectric layers. After first piezoelectric layer 180a is grown on the first substrate or wafer 715 and the second piezoelectric layer 182a is grown on the second substrate or wafer 730, some or all the substrates are etched and one of the piezoelectric layers is flipped and bonded to the surface of the other piezoelectric layer opposite to its respective electrode.

In at least one example, after forming bottom electrode 164a on the top of the surface of second piezoelectric layer 182a, which is grown on the second substrate or wafer 730, the second substrate is etched. Thereafter, the surface of second piezoelectric layer 182a opposite to bottom electrode 164a is bonded to the surface of first piezoelectric layer 180a which was grown on the first substrate or wafer 715. In at least one example, the same piezoelectric material is used for first piezoelectric layer 180a and second piezoelectric layer 182a and with the same poling directions. By flipping one of the piezoelectric layers before bonding the surface of the piezoelectric layers opposite to the respective electrodes, the poling direction of one of the piezoelectric layers becomes opposite to the poling direction of the other piezoelectric layer.

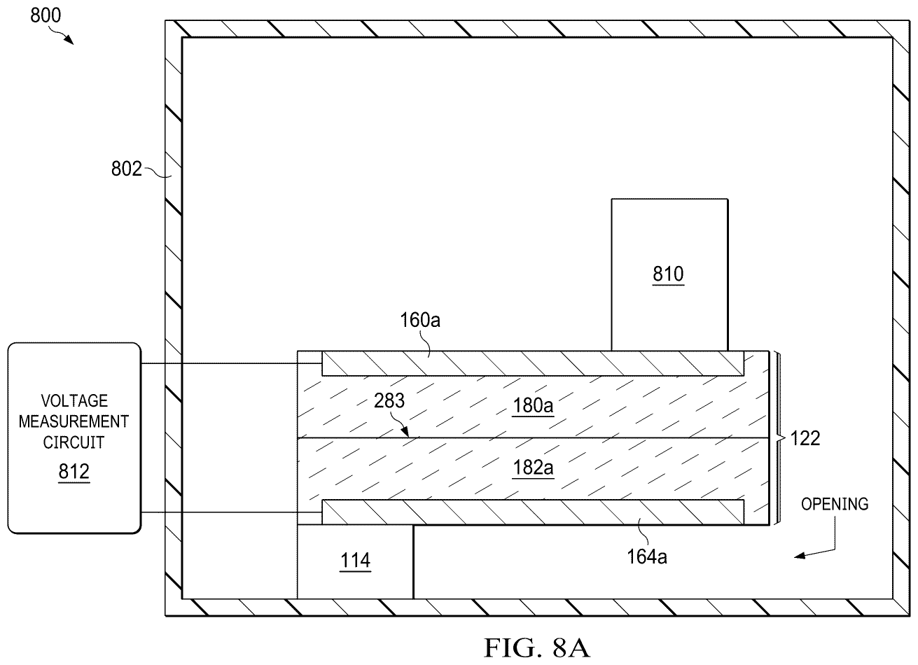

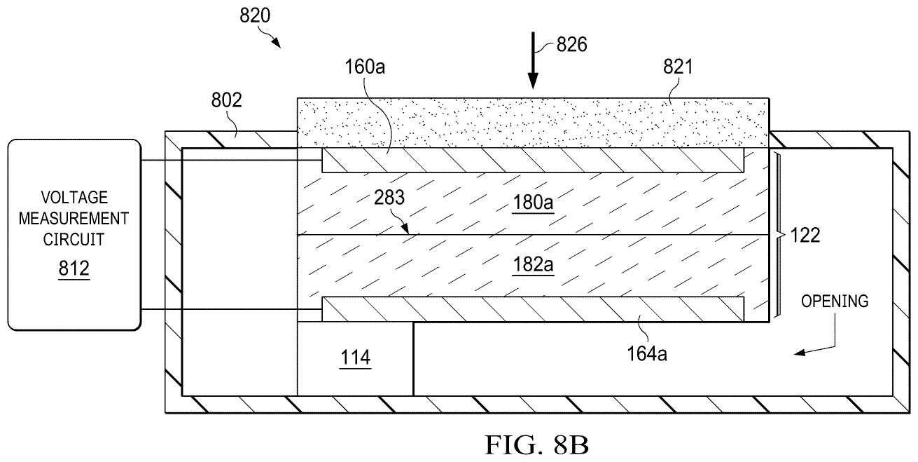

FIG. 8A is a schematic illustrating a transducer configured as an accelerometer 800, in accordance with at least one example. Accelerometer 800 includes bimorph piezoelectric cantilever 122 anchored on semiconductor structure 114 and suspended over an opening. In at least one example, bimorph piezoelectric cantilever 122 is enclosed in an enclosure 802. Accelerometer also includes mass 810, where mass 810 (e.g., a metal layer) is coupled to bimorph piezoelectric cantilever 122. As accelerometer moves, mass 810 exerts force on bimorph piezoelectric cantilever 122. The stress on bimorph piezoelectric cantilever 122 results in an electric field between first electrode 160a and second electrode 164a. The electric field E is sensed as a voltage between first electrode 160a and second electrode 164a by a voltage measurement circuit 812. The voltage represents the acceleration (or speed of movement) of accelerometer 800.

FIG. 8B is a schematic illustrating a transducer configured as a sensor 820, in accordance with at least one example. In at least one example, bimorph piezoelectric cantilever 122 is used to sense the presence or absence of a device or material. In at least one example, bimorph piezoelectric cantilever 122 is enclosed in enclosure 802 and a sensor membrane 821. Sensor membrane 821 is mechanically coupled to or directly attached on top electrode 160a or first piezoelectric layer 180a. Sensor membrane 821 can transfer a force 826 onto bimorph piezoelectric cantilever 122. Force 826 stresses the piezoelectric layers of bimorph piezoelectric cantilever 122 to bend. The bending of first and second piezoelectric layers 180a and 182a results in an electric field between first electrode 160a and second electrode 164a. The electric field E is sensed as a voltage between first electrode 160a and second electrode 164a by a voltage measurement circuit 812. The voltage represents the sensed force 826.

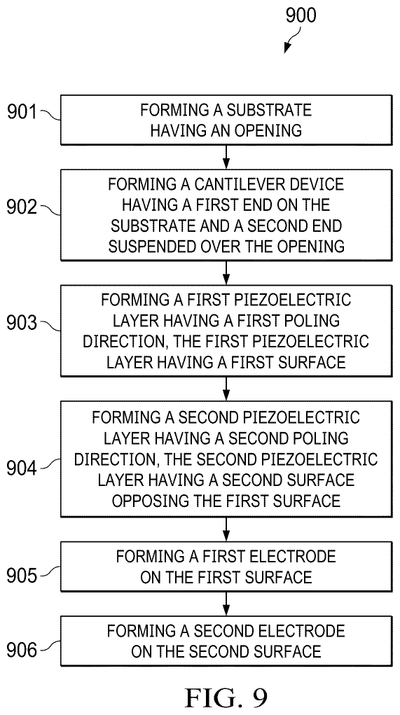

FIG. 9 is a flowchart 900 of a method of forming a transducer, in accordance with at least one example. While various blocks of flowchart 900 are illustrated in a particular order, the order can be modified. For example, some blocks may be performed before others while some blocks may be performed simultaneously. The method of forming the cantilever of various examples herein may involve fabrication processes, tools, and software to execute the various blocks.

At block 901, a substrate (e.g., semiconductor structure 114) is formed and etched to have an opening (e.g., opening 516). At block 902, bimorph piezoelectric cantilever 122 is formed on the substrate such that a first end of bimorph piezoelectric cantilever 122 is on the substrate while a second end of bimorph piezoelectric cantilever 122 is suspended over the opening. The opening allows bimorph piezoelectric cantilever 122 to vibrate based on a stimulus. Blocks 903 through 906 describe the formation of bimorph piezoelectric cantilever 122.

At block 903, bimorph piezoelectric cantilever 122 is formed by forming or growing first piezoelectric layer 180a having a first poling direction. Forming bimorph piezoelectric cantilever 122 further includes forming or growing second piezoelectric layer 182a having a second poling direction from the first poling direction. In at least one example, the second poling direction has a second component which is different (e.g., opposite) to a first component of the first poling direction. In at least one example, the first component and the second component have the same magnitude and opposite directions. In at least one example, the first and second components are along an axis orthogonal to the first surface (and the neutral axis). In at least one example, first piezoelectric layer 180a has a different crystallinity or crystallization than second piezoelectric layer 182a. For instance, first piezoelectric layer 180a has a first crystallinity or crystallization which is a flipped mirror image of a second crystallinity of crystallization of second piezoelectric layer 182a.At block 905, first electrode 160a is formed on first surface 205a of first piezoelectric layer 180a. At block 906, second electrode 164a is formed on a second surface (e.g., fourth surface 206b) which is opposite to first surface 205a.

Various blocks may be performed in a different order. For example, after the substrate or semiconductor structure 114 is formed, second electrode 164a is fabricated on the substrate (block 906). Thereafter, second piezoelectric layer 182a is grown on second electrode 164a (block 904). On the top surface of second piezoelectric layer 182a, first piezoelectric layer 180a is grown, where first piezoelectric layer 180a has a poling direction with a component opposite to a component of the poling direction of second piezoelectric layer 182a (block 903). Subsequently, first electrode 160a is formed on the top surface of first piezoelectric layer 180a (block 905).

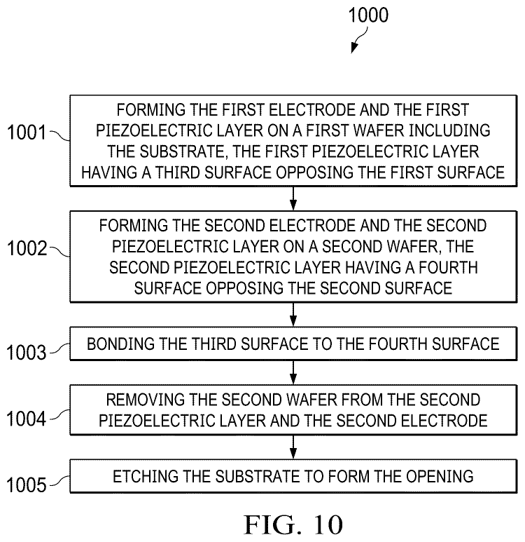

FIG. 10 is a flowchart 1000 of a method of forming a transducer with two wafers, in accordance with at least one example. While various blocks of flowchart 1000 are illustrated in a particular order, the order can be modified. For example, some blocks may be performed before others while some blocks may be performed simultaneously. The method of forming the cantilever of various examples herein may involve fabrication processes, tools, and software to execute the various blocks.

Blocks 903 through 906 can be replaced with blocks 1001 through 1005, in accordance with at least one example. At block 1001, first electrode 160a and first piezoelectric layer 180a are formed on first substrate or wafer 715. At block 1002, second electrode 162a and second piezoelectric layer 182a is formed on second substrate or wafer 730. At block 1003, a third surface of first piezoelectric layer 180a which is opposite to first surface 205a is bonded with a fourth surface of second piezoelectric layer 182a, which is opposite to the surface on which second electrode 164a is formed. The bonding process involves etching or removing the second substrate or wafer 730, which exposes the fourth surface of second piezoelectric layer 182a as indicated by block 1004. In at least one example, a bonding material is deposited on the fourth surface of second piezoelectric layer 182a and/or the third surface of first piezoelectric layer 180a. In at least one example, instead of a bonding material, the fourth surface of second piezoelectric layer 182a and the third surface of first piezoelectric layer 180a are bonded under a certain temperature and pressure.

The process of forming the cantilever involves flipping second piezoelectric layer 182a and associated electrode 164a prior to etching the second substrate or wafer 730. By flipping second piezoelectric layer 182a, at least a component of poling direction of second piezoelectric layer 182a becomes opposite to a component of poling direction of second piezoelectric layer 182a. At block 1005, first substrate or wafer 715 is etched to form an opening such that a part of second piezoelectric layer 182a suspends over the opening.

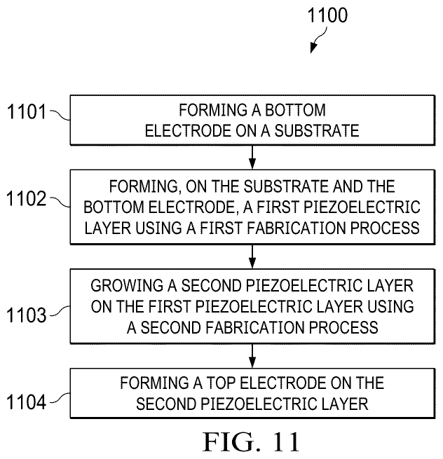

FIG. 11 is a flowchart 1100 of a method of forming a transducer with piezoelectric layers fabricated with different processes, in accordance with at least one example. While various blocks of flowchart 1100 are illustrated in a particular order, the order can be modified. For example, some blocks may be performed before others while some blocks may be performed simultaneously. The method of forming the cantilever of various examples herein may involve fabrication processes, tools, and software to execute the various blocks.

Blocks 903 through 906 can be replaced with blocks 1001 through 1005, in accordance with at least one example. At block 1101, bottom electrode 164a is formed on substrate or semiconductor structure 114. At block 1102, a first piezoelectric material (e.g., second piezoelectric layer 182a) is deposited or grown on bottom electrode 164a using a first fabrication process (e.g., metal organic chemical vapor deposition (MOCVD)). At block 1103, a second piezoelectric material (e.g., first piezoelectric layer 180a) is deposited or grown on the first piezoelectric material using a second fabrication process (e.g., chemical vapor deposition process). By using two different processing methods for growing the first piezoelectric material and the second piezoelectric material, at least one component of the poling direction of first piezoelectric material is opposite (e.g., equal in magnitude but opposite in direction or sign) to at least one component of the poling direction of second piezoelectric material. At block 1104, first electrode 160a (e.g., top electrode) is formed over the second piezoelectric material.

The following are additional examples provided in view of the above-described implementations. Here, one or more features of example, in isolation or in combination, can be combined with one or more features of one or more other examples to form further examples also falling within the scope of the disclosure. As such, one implementation can be combined with one or more other implementation without changing the scope of disclosure.

Example 1 is an apparatus comprising: a substrate having an opening; and a cantilever device having a first end on the substrate and a second end suspended over the opening, the cantilever device including: a first piezoelectric layer having a first surface, the first piezoelectric layer having a first poling direction; a second piezoelectric layer having a second surface opposing the first surface, the second piezoelectric layer having a second poling direction, the second poling direction being different from the first poling direction; a first electrode on the first surface; and a second electrode on the second surface.

Example 2 is an apparatus according to any example herein, particularly example 1, wherein the first poling direction has a first component along an axis orthogonal to the first surface, the second poling direction has a second component along the axis, the first component and the second component having same magnitude and opposite directions.

Example 3 is an apparatus according to any example herein, particularly example 1, wherein the first poling direction has a first component along a first axis, wherein the first axis is orthogonal to a second axis between the first end and the second end.

Example 4 is an apparatus according to any example herein, particularly example 1, wherein the first poling direction is associated with a first piezoelectric coupling coefficient, wherein the second poling direction is associated with a second piezoelectric coupling coefficient, and wherein the second piezoelectric coupling coefficient and the first piezoelectric coupling coefficient have an identical magnitude.

Example 5 is an apparatus according to any example herein, particularly example 1, wherein the first piezoelectric layer abuts the second piezoelectric layer.

Example 6 is an apparatus according to any example herein, particularly example 1, wherein the cantilever device further includes a bonding layer between the first piezoelectric layer and the second piezoelectric layer.

Example 7 is an apparatus according to any example herein, particularly example 1, wherein the first piezoelectric layer and the second piezoelectric layer have identical thickness.

Example 8 is an apparatus according to any example herein, particularly example 1, wherein the first piezoelectric layer and the second piezoelectric layer have opposite crystal orientations.

Example 9 is an apparatus according to any example herein, particularly example 1, wherein the first piezoelectric layer and the second piezoelectric layer include identical piezoelectric material.

Example 10 is an apparatus according to any example herein, particularly example 1, wherein the first piezoelectric layer and the second piezoelectric layer include different piezoelectric materials.

Example 11 is an apparatus according to any example herein, particularly example 1, wherein the first electrode and the second electrode extend along no more than half of a respective length of the first piezoelectric layer and the second piezoelectric layer.

Example 12 is an apparatus according to any example herein, particularly example 1, wherein the cantilever device is configured as one of: a piezoelectric microphone, piezoelectric speaker, a piezoelectric micromachine ultrasonic transducer, a piezoelectric accelerometer, or an audio accelerometer.

Example 13 is an apparatus comprising: a substrate having an opening; and a cantilever device having a first end on the substrate and a second end suspended over the opening, the cantilever device including: a first piezoelectric layer having a first surface, the first piezoelectric layer having a first poling direction; a second piezoelectric layer having a second surface opposing the first surface, the second piezoelectric layer having a second poling direction different from the first poling direction; a first electrode on the first surface; and a second electrode on the second surface.

Example 14 is an apparatus according to any example herein, particularly example 13, wherein the first poling direction has a first component along an axis orthogonal to the first surface, the second poling direction has a second component along the axis, the first component and the second component having same magnitude and opposite directions.

Example 15 is an apparatus according to any example herein, particularly example 13, wherein the first poling direction corresponds to a first crystal orientation of the first piezoelectric layer, wherein the second poling direction corresponds to a second crystal orientation of the second piezoelectric layer, and wherein the second crystal orientation is different from the first crystal orientation.

Example 16 is an apparatus according to any example herein, particularly example 13, wherein the first poling direction corresponds to a first coupling coefficient of the first piezoelectric layer, wherein the second poling direction corresponds to a second coupling coefficient of the second piezoelectric layer, and wherein the second coupling coefficient is of opposite polarity from the first coupling coefficient.

Example 17 is an apparatus according to any example herein, particularly example 13, wherein the first piezoelectric layer and the second piezoelectric layer include an identical piezoelectric material, or wherein the first piezoelectric layer and the second piezoelectric layer include different piezoelectric materials.

Example 18 is an apparatus according to any example herein, particularly example 13, including: a case; an integrated circuit; and a device coupled to the integrated circuit, wherein the integrated circuit and the device are covered by the case, and wherein the device includes the substrate and the cantilever device.

Example 19 is an apparatus according to any example herein, particularly example 18, wherein the integrated circuit is configured to operate the device as one of a piezoelectric microphone, piezoelectric speaker, a piezoelectric micromachine ultrasonic transducer, a piezoelectric accelerometer, or an audio accelerometer.

Example 20 is a method comprising: forming a substrate having an opening; and forming a cantilever device having a first end on the substrate and a second end suspended over the opening, wherein forming the cantilever device includes: forming a first piezoelectric layer having a first poling direction, the first piezoelectric layer having a first surface; forming a second piezoelectric layer having a second poling direction different from the first poling direction, the second piezoelectric layer having a second surface opposing the first surface; forming a first electrode on the first surface; and forming a second electrode on the second surface.

Example 21 is a method according to any example herein, particularly example 20, wherein: forming the first electrode and forming the first piezoelectric layer includes forming the first electrode and the first piezoelectric layer on a first wafer including the substrate, the first piezoelectric layer having a third surface opposing the first surface; forming the second electrode and forming the second piezoelectric layer includes forming the second electrode and the second piezoelectric layer on a second wafer, the second piezoelectric layer having a fourth surface opposing the second surface; forming the cantilever device includes: bonding the third surface to the fourth surface; removing the second wafer from the second piezoelectric layer and the second electrode; and etching the substrate to form the opening.

Example 22 is a method according to any example herein, particularly example 20, wherein forming the second piezoelectric layer includes forming the second piezoelectric layer on the first piezoelectric layer.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuit or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuit. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

What is claimed is:

1. An apparatus comprising:
a substrate having an opening; and
a cantilever device having a first end on the substrate and a second end suspended over the opening, the cantilever device including:
a first piezoelectric layer having a first surface, the first piezoelectric layer having a first poling direction;
a second piezoelectric layer having a second surface opposing the first surface, the second piezoelectric layer having a second poling direction, the second poling direction being different from the first poling direction;
a first electrode on the first surface; and
a second electrode on the second surface.

2. The apparatus of claim 1, wherein the first poling direction has a first component along an axis orthogonal to the first surface, the second poling direction has a second component along the axis, the first component and the second component having same magnitude and opposite directions.

3. The apparatus of claim 1, wherein the first poling direction has a first component along a first axis, wherein the first axis is orthogonal to a second axis between the first end and the second end.

4. The apparatus of claim 1, wherein the first piezoelectric layer has a first piezoelectric coupling coefficient, wherein the second piezoelectric layer has a second piezoelectric coupling coefficient, and wherein the second piezoelectric coupling coefficient and the first piezoelectric coupling coefficient have an identical magnitude and opposite polarities.

5. The apparatus of claim 1, wherein the first piezoelectric layer abuts the second piezoelectric layer.

6. The apparatus of claim 1, wherein the cantilever device further includes a bonding layer between the first piezoelectric layer and the second piezoelectric layer.

7. The apparatus of claim 1, wherein the first piezoelectric layer and the second piezoelectric layer have identical thickness.

8. The apparatus of claim 1, wherein the first piezoelectric layer and the second piezoelectric layer have opposite crystal orientations.

9. The apparatus of claim 1, wherein the first piezoelectric layer and the second piezoelectric layer include identical piezoelectric material.

10. The apparatus of claim 1, wherein the first piezoelectric layer and the second piezoelectric layer include different piezoelectric materials.

11. The apparatus of claim 1, wherein the first electrode and the second electrode extend along no more than half of a respective length of the first piezoelectric layer and the second piezoelectric layer.

12. The apparatus of claim 1, wherein the cantilever device is configured as one of: a piezoelectric microphone, piezoelectric speaker, a piezoelectric micromachine ultrasonic transducer, a piezoelectric accelerometer, or an audio accelerometer.

13. An apparatus comprising:
a substrate having an opening; and
a cantilever device having a first end on the substrate and a second end suspended over the opening, the cantilever device including:
a first piezoelectric layer having a first surface, the first piezoelectric layer having a first intrinsic polarization direction;
a second piezoelectric layer having a second surface opposing the first surface, the second piezoelectric layer having a second intrinsic polarization direction different from the first intrinsic polarization direction;
a first electrode on the first surface; and
a second electrode on the second surface.

14. The apparatus of claim 13, wherein the first intrinsic polarization direction has a first component along an axis orthogonal to the first surface, the second intrinsic polarization direction has a second component along the axis, the first component and the second component having same magnitude and opposite directions.

15. The apparatus of claim 13, wherein the first intrinsic polarization direction corresponds to a first crystal orientation of the first piezoelectric layer, wherein the second intrinsic polarization direction corresponds to a second crystal orientation of the second piezoelectric layer, and wherein the second crystal orientation is different from the first crystal orientation.

16. The apparatus of claim 13, wherein the first piezoelectric layer has a first piezoelectric coupling coefficient, wherein the second piezoelectric layer has a second piezoelectric coupling coefficient, and wherein the first and second coupling coefficients have a same magnitude and opposite polarities.

17. The apparatus of claim 13, wherein the first piezoelectric layer and the second piezoelectric layer include an identical piezoelectric material.

18. The apparatus of claim 13 including:
a case;
an integrated circuit; and
a device coupled to the integrated circuit, wherein the integrated circuit and the device are covered by the case, and wherein the device includes the substrate and the cantilever device.

19. The apparatus of claim 18, wherein the integrated circuit is configured to operate the device as one of a piezoelectric microphone, piezoelectric speaker, a piezoelectric micromachine ultrasonic transducer, a piezoelectric accelerometer, or an audio accelerometer.

20. A method comprising:
forming a substrate having an opening; and
forming a cantilever device having a first end on the substrate and a second end suspended over the opening, wherein forming the cantilever device includes:
forming a first piezoelectric layer having a first poling direction, the first piezoelectric layer having a first surface; forming a second piezoelectric layer having a second poling direction different from the first poling direction, the second piezoelectric layer having a second surface opposing the first surface;
forming a first electrode on the first surface; and
forming a second electrode on the second surface.

21. The method of claim 20, wherein:
forming the first electrode and forming the first piezoelectric layer includes forming the first electrode and the first piezoelectric layer on a first wafer including the substrate, the first piezoelectric layer having a third surface opposing the first surface;
forming the second electrode and forming the second piezoelectric layer includes forming the second electrode and the second piezoelectric layer on a second wafer, the second piezoelectric layer having a fourth surface opposing the second surface; and
forming the cantilever device includes:
bonding the third surface to the fourth surface; removing the second wafer from the second piezoelectric layer and the second electrode; and
etching the substrate to form the opening.

22. The method of claim 20, wherein forming the second piezoelectric layer includes forming the second piezoelectric layer on the first piezoelectric layer.
